(19) United States
(12) Patent Application Publication
(10) Pub. No.: US 2014/0280617 A1
(43) Pub. Date: Sep. 18, 2014

(54) Methods and Systems for Generating Social Media Messages

(71) Applicants: Shaun Michael Nilsson, Toronto (CA); Alen Stephan Bubic, Toronto (CA)

(72) Inventors: Shaun Michael Nilsson, Toronto (CA); Alen Stephan Bubic, Toronto (CA)

(21) Appl. No.: 13/826,609

(22) Filed: Mar. 14, 2013

(51) Int. Cl. H04L 12/58

(52) U.S. Cl. CPC H04L 51/32
USPC 709/206

(57) ABSTRACT

A method and system are provided for generating social media messages. The method and system involve storing, in a storage module, a user profile corresponding to each user in a plurality of users and at least one message content in a plurality of message contents, the user profile includes a content indicator corresponding to one or more categories of message content selected by a corresponding user; and operating at least one processor module to associate each message content in the plurality of message contents with at least one category in a plurality of categories; determine, for at least one user in the plurality of users, one or more categories using the content indicator associated with the user; and a message content based on the determined one or more categories; and create the social media message based on the determined message content.

### FIELD

The described embodiments relate to methods and systems for generating social media messages.

### BACKGROUND

Social media networks are generally characterized by large and evolving communities. As a result, social media networks are becoming crucial platforms for mass content distribution. A user account within a social media network is typically associated with connections with many other users within that social media network. Users are typically connected to users with whom they are familiar, such as family members, friends, co-workers, or classmates, or with whom they share a common interest. Therefore, when a social media message is posted on a user account, that social media message is likely to have a relatively captive and interested audience.

Although social media networks provide a platform for mass content distribution, the content is generated by users and so, the effectiveness of a user account on any social media network relies heavily on the ability of that user to constantly create up-to-date social media messages. It may be difficult for users to maintain a regular social media presence.

### SUMMARY

The various embodiments described herein generally relate to methods (and associated systems configured to implement the methods) for generating social media messages. To generate social media messages for a user, the content system determines at least one category based on a content indicator associated with that user and a message content based on the determined category. The content system may then create a social media message for that user based on the determined message content.

In accordance with an embodiment of the invention, there is provided a method for generating a social media message, the method comprising: storing, in a storage module, a user profile corresponding to each user in a plurality of users and at least one message content in a plurality of message contents, the user profile includes a content indicator corresponding to one or more categories of message content selected by a corresponding user; and operating at least one processor module to associate each message content in the plurality of message contents with at least one category in a plurality of categories; to determine, for at least one user in the plurality of users, one or more categories from the plurality of categories using the content indicator associated with the at least one user; and a message content from the plurality of message contents based on the determined one or more categories; and to create, for the at least one user, the social media message based on the determined message content.

In accordance with an embodiment of the invention, there is provided a system for generating a social media message, the system comprising at least one processor module configured to store, in a storage module, a user profile corresponding to each user in a plurality of users and at least one message content in a plurality of message contents, the user profile includes a content indicator corresponding to one or more categories of message content selected by a corresponding user; to associate each message content in the plurality of message contents with at least one category in a plurality of categories; to determine, for at least one user in the plurality of users, one or more categories from the plurality of categories using the content indicator associated with the at least one user; and a message content from the plurality of message contents based on the determined one or more categories; and to create, for the at least one user, the social media message based on the determined message content.

In accordance with another embodiment of the invention, there is provided a method for generating a social media message, the method comprising: storing, in a storage module, a user profile corresponding to each user in a plurality of users and at least one real estate content in a plurality of real estate contents, the user profile includes a real estate interest indicator corresponding to one or more categories of real estate contents selected by a corresponding user; and operating at least one processor module to associate each real estate content in the plurality of real estate contents with at least one category in a plurality of categories; to determine, for at least one user in the plurality of users, one or more categories from the plurality of categories using the real estate interest indicator associated with the at least one user; and a real estate content from the plurality of real estate contents based on the determined one or more categories; and to create, for the at least one user, the social media message based on the determined real estate content.

In accordance with another embodiment of the invention, there is provided a system for generating a social media message, the system comprising at least one processor module configured to store, in a storage module, a user profile corresponding to each user in a plurality of users and at least one real estate content in a plurality of real estate contents, the user profile includes a real estate interest indicator corresponding to one or more categories of real estate contents selected by a corresponding user; to associate each real estate content in the plurality of real estate contents with at least one category in a plurality of categories; to determine, for at least one user in the plurality of users, one or more categories from the plurality of categories using the real estate interest indicator associated with the at least one user; and a real estate content from the plurality of real estate contents based on the determined one or more categories; and to create, for the at least one user, the social media message based on the determined real estate content.

In accordance with yet another embodiment of the invention, there is provided a method for generating a social media message for at least one user in the plurality of users, the method comprising: storing, in a storage module, a user profile corresponding to each user in the plurality of users and at least one real estate content in a plurality of real estate contents, the user profile includes a real estate interest indicator corresponding to one or more categories of real estate contents selected by a corresponding user; and operating at least one processor module to associate each real estate content in the plurality of real estate contents with at least one category in a plurality of categories; to determine, for the least one user, one or more categories from the plurality of categories using the real estate interest indicator associated with the at least one user; and a real estate content from the plurality of real estate contents based on the determined one or more categories; and to create, for the at least one user, the social media message based on the determined real estate content and the user profile of the at least one user, the social media message being associated with a user identifier corresponding to the at least one user.

In accordance with yet another embodiment of the invention, there is provided a system for generating a social media message for at least one user in the plurality of users, the system comprising at least one processor module configured to store, in a storage module, a user profile corresponding to each user in the plurality of users and at least one real estate content in a plurality of real estate contents, the user profile includes a real estate interest indicator corresponding to one or more categories of real estate contents selected by a corresponding user; to associate each real estate content in the plurality of real estate contents with at least one category in a plurality of categories; to determine, for the least one user, one or more categories from the plurality of categories using the real estate interest indicator associated with the at least one user; and a real estate content from the plurality of real estate contents based on the determined one or more categories; and to create, for the at least one user, the social media message based on the determined real estate content and the user profile of the at least one user, the social media message being associated with a user identifier corresponding to the at least one user.

### BRIEF DESCRIPTION OF THE DRAWINGS

Several embodiments of the present invention will now be described in detail with reference to the drawings, in which:

FIG. 1 is a block diagram of components interacting with a content system in accordance with an example embodiment;

FIG. 2 is a flowchart of an example embodiment of various methods of generating social media messages;

FIGS. 3A and 3B are screenshots of an interface for receiving message content in accordance with an example embodiment;

FIGS. 4A and 4B are screenshots of an interface for receiving real estate content in accordance with an example embodiment;

FIGS. 5A to 5C are screenshots of social media messages in accordance with an example embodiment;

FIG. 6 is a screenshot of a social media message in accordance with another example embodiment;

FIGS. 7A and 7B are screenshots of social media messages in accordance with another example embodiment;

FIGS. 8A to 8C are screenshots of social media messages in accordance with a further example embodiment;

FIG. 9A is a screenshot of an interface for displaying real estate content in accordance with an example embodiment;

FIG. 9B is a screenshot of an interface for contacting a user associated with the real estate content shown in FIG. 9A in accordance with an example embodiment; and

FIG. 10 is a screenshot of social media statistics for a user in accordance with an example embodiment.

The drawings, described below, are provided for purposes of illustration, and not of limitation, of the aspects and features of various examples of embodiments described herein. The drawings are not intended to limit the scope of the teachings in any way. For simplicity and clarity of illustration, elements shown in the figures have not necessarily been drawn to scale. The dimensions of some of the elements may be exaggerated relative to other elements for clarity. It will be appreciated that for simplicity and clarity of illustration, where considered appropriate, reference numerals may be repeated among the figures to indicate corresponding or analogous elements.

### DESCRIPTION OF EXEMPLARY EMBODIMENTS

The various embodiments described herein generally relate to methods (and associated systems configured to implement the methods) for generating social media messages. The method includes storing user profiles for each user and at least one message content in a storage module. The user profile includes, at least, a content indicator that generally corresponds to one or more categories of message content selected by a corresponding user. A content system may associate each message content with at least one category. To generate the social media message for a user, the content system may determine at least one category based on the content indicator associated with that user and a message content based on the determined category. The content system may then create a social media message for that user based on the determined message content. After the social media message is generated, the content system may further distribute that social media message to one or more social media servers associated with that user.

The content system may also store supplemental content for each message content. As will be described below, the supplemental content may include images and descriptions. When generating the social media message, the content system may determine at least one supplemental content and include that supplemental content in the social media message.

Social media networks are becoming crucial platforms for mass content distribution. Users of the social media networks, however, may have difficulty maintaining their user accounts on the various social media servers. Some users may not be familiar with the operation of the different social media networks provided on the social media servers and have difficulty adding content, or messages, onto their user accounts associated with those social media servers. Also, maintaining a regular and effective social media presence can be quite time-consuming. Some users may not have time to constantly post and update messages on their social media accounts. By enabling the content system to automatically generate social media messages on behalf of users, users may benefit from an increased social media presence with minimal effort. The increased social media presence may also be customized by the users. For example, users can manage their social media presence by customizing their user profiles, such as by editing the corresponding content indicator.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

The embodiments of the systems and methods described herein may be implemented in hardware or software, or a combination of both. However, preferably, these embodiments are implemented in computer programs executing on programmable computers each comprising at least one processor module (e.g., a microprocessor), a data storage system (including volatile and non-volatile memory and/or storage elements), at least one input device, and at least one output device. For example and without limitation, the programmable computers (referred to below as computing devices) may be a personal computer, laptop, personal data assistant, cellular telephone, smart-phone device, tablet computer, and/or wireless device. Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The subject system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Reference is first made to FIG. 1, which illustrates a block diagram 100 of components interacting with a content system 110. The content system 110 interacts with a storage module 120, one or more social media servers 130 and a user device 140 via a network 150.

Storage module 120 may be provided using a data storage system. The storage module 120 may include one or more databases that are implemented with any database implementations. Although the storage module 120 is illustrated in FIG. 1 to be separate from the content system 110, the storage module 120, or at least a part of the storage module 120, may be provided within the content system 110.

The storage module 120 may store information related to users of the content system 110, information related to various message contents and other information for the operation of the content system 110. The information stored on the storage module 120 may be received from the user device 140 via the content system 110 and from the content system 110 via the network 150. The stored information may be accessed by the content system 110 via the network 150.

The information stored in the storage module 120 may include a user profile for each user. The user profile may include general user information, such as a user identifier for identifying a user, personal information (e.g., occupation, phone numbers, e-mail addresses, etc.), geographical proximities or locations (e.g., Eastern Canada or Toronto, Ontario), general interest information (e.g., hobbies, etc.) and a content indicator identifying categories of message content selected by the user.

The content indicator may be associated with one or more category identifiers. For example, the category identifiers can include, at least, an identifier for a geographical area category, an identifier for a subject category (e.g., informational identifier, lifestyle identifier, home inspection identifier, real estate identifier, insurance identifier, fitness identifier, mortgage identifier, etc.), and an identifier for a content type category (e.g., article identifier, blog identifier or real estate listing identifier).

In some embodiments, the content indicator includes a real estate interest indicator for identifying one or more categories of real estate contents selected by a user. Like the content indicator, the real estate interest indicator can include one or more category identifiers that are related to real estate. For example, the real estate category identifiers can include, without limitations, an identifier for a geographical area category, an identifier for a subject category (e.g., informational identifier, home inspection identifier, real estate insurance identifier, mortgage identifier, etc.), an identifier for a content type category (e.g., article identifier, blog identifier or real estate listing identifier), and an identifier for a type of property (e.g., condominium, house, townhouse, vacation home, etc.).

The user profile may also be associated with one or more social media servers 130. In some embodiments, the user profile can further be associated with corresponding authentication information for each associated social media server 130.

The storage module 120 may also store information related to message contents. Message contents may include any data information that can be included in a social media message generated by the content system 110 and distributed by the content system 110 to a user account associated with a social media server 130. For example, a message content can include a combination of one or more of a text data, an image data, a video data and a Universal Resource Locator (URL) corresponding to a webpage. The URL may be associated with an article or a blog entry. It will be understood that the message content may include other similar types of data.

For each message content, the storage module 120 may also store supplemental contents. The supplemental contents may include at least one image that is associated with the message content and at least one description associated with the message content. The image may be image data that is related to the topic of the message content or a category associated with the message content. The description may include text data that generally introduces the topic or scope of the message content or a category associated with the message content.

Each message content may also be associated with an expiry date. The expiry date generally indicates a date on which that message content is no longer valid or current. The content system 110 may then remove that message content from the storage module 120 on the expiry date or prevent that message content from being available for use, such as by associating that message content with a status indicating that the message content is invalid.

Social media servers 130 are server computers associated with various different social media networks. It will be understood that a social media network may be associated with one or more social media servers 130. Without limitations, the social media networks may include Facebook™, Google+™, a fan page on Facebook, LinkedIn™, Twitter™ and MySpace™. It will be understood that the content system 110 may similarly interact with other social media networks provided by other social media servers 130 via the network 150.

User device 140 may be any computing device capable of network communication. For example, and without limitation, the user device 140 can be a personal computer, laptop, personal data assistant, cellular telephone, smart-phone device, tablet computer, and/or wireless device. For ease of exposition, only one user device 140 is shown in FIG. 1 but it will be understood that multiple user devices 140 can communicate with the content system 110 via the network 150 at any given time.

Content system 110 may be provided as one or more server computers. It will be understood that the server computers may be distributed over a wide geographic area and connected via the network 150. As illustrated in FIG. 1, the content system 110 includes, at least, a processor module 112 and an interface module 114.

Processor module 112 includes hardware and software components for providing computing processing abilities and memory such as a database(s) or file system(s). As will be described below, the processor module 112 can operate to generate social media messages. For ease of exposition, only one processor module 112 is shown in FIG. 1 but it will be understood that one or more processor modules 112 can be provided. The one or more processor modules 112 may be provided within the content system 110, or separate from the content system 110 but able to communicate with the content system 110 via the network 150 at any given time.

Interface module 114 provides a communication interface for the content system 110. The interface module 114 enables connection to the network 150, for example, to communicate with the user device 140, storage module 120 and the social media servers 130. The interface module 114 may also provide user interfaces from which message contents may be received by the content system 110.

Network 150 may be any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these, capable of interfacing with, and enabling communication between, the content system 110, the user device 140, the storage module 120, and the social media servers 130.

Referring now to FIG. 2, which is a flowchart 200 of an example method of generating social media messages. To illustrate the example method, reference will be made simultaneously to FIGS. 3A, 3B, 4A and 4B, which illustrate screenshots of example interfaces for receiving message contents from a user, and FIGS. 5A to 8C, which illustrate screenshots of example social media messages. It will be understood that the content system 110 may receive the message contents from a user via user device 140 or the interface module 114, or from the storage module 120.

At 210, the processor module 112 stores, in the storage module 120, a user profile corresponding to each user in a plurality of users and at least one message content in a plurality of message contents.

As described above, a user profile is stored in the storage module 120 for each user. The user profile may include information associated with the user and user preferences, such as the content indicator. The content indicator generally corresponds to one or more categories of message content selected by the user. In some embodiments, the content indicator may include a real estate interest indicator that is associated with one or more categories of real estate contents selected by the user. The content indicator, therefore, may act as a guide for the content system 110 to determine the types of message contents that the user would like to have included in a social media message.

The user profile may also be associated with at least one social media server 130. The user profile may further include authentication information corresponding to the associated social media servers 130. For example, a user with a Facebook user account and a Twitter user account may want social media messages to be generated for both the Facebook and Twitter accounts. The content system 110 can determine from a user profile that the user is associated with the social media networks, Facebook and Twitter. The content system 110 can then generate social media messages for the user for the associated social media servers 130 corresponding to Facebook and Twitter.

The processor module 112 may receive message contents from a user via the user device 140 or the interface module 114, or from an external data source. For example, a listing agent can provide a message content related to a real estate listing to the content system 110 via a user interface provided by the interface module 114. In another example, the processor module 112 can receive message contents directly from a proprietary data service, such as the Multiple Listing Service™ (MLS™).

In some embodiments, the storage module 120 may receive the message content directly from the external data source and the processor module 112 may then receive the message content from the storage module 120 via the network 150.

Reference is now made to FIG. 3A, which illustrates a screenshot 300 of a message content interface 306 for receiving a message content 310. It will be understood that the illustrated message content interface 306 is only for illustrative purpose and that different data fields may be used.

The message content interface 306 may include various data fields for receiving data associated with the message content 310. The data fields may include a title field 312, a category dropdown list 314, a subtitle field 316 and one or more content fields 360. The title field 312 receives a title for the message content 310 and the subtitle field 316 receives a descriptive title for the message content 310. It will be understood that the title field 312 and the subtitle field 316 may receive the same data. The category dropdown list 314 provides a list of categories from which at least one category can be selected to be associated with the message content 310.

The content fields 360 may include one or more different data fields for receiving data associated with the message content 310. In FIG. 3A, a content URL field 362 is provided for receiving a URL associated with the message content 310 and a content control 364 is also provided for allowing additional data, such as text data, image data or video data, to be included in the message content 310. For example, the message content 310 may include a URL provided through the content URL field 362 and an image data provided using the content control 364. In another example, the message content 310 can include only data provided using the content control 364. That is, the message content 310 can include only text data, such as an inspirational quote, or image data, such as an image of designer decor. It will be understood that the message content 310 may include any combination of data received from the content URL field 362 and provided using the content control 364.

As noted above, the data fields shown in FIG. 3A are provided for illustrative purposes. For example, the processor module 112 may instead receive the message content 310 using only the content fields 360. That is, the title field 312, the subtitle field 316 and the category dropdown list 314 may be optional or form part of the supplemental content.

In the example of FIG. 3A, the message content 310 includes a title “Inside Celebrity Homes” received from the title field 312 and a subtitle “Inside a Celebrity's Magical Malibu Mansion” received from the subtitle field 316. The category selected from the category dropdown list 314 is “informational”. A URL is also provided for the message content 310 through the content URL field 362.

The processor module 112 may also receive supplemental content for each message content 310. The processor module 112 may store the supplemental content in the storage module 120.

Reference is now made to FIG. 3B, which illustrates a screenshot 302 of another message content interface 306′ for receiving the message content 310. It will be understood that, like the message content interface 306 of FIG. 3A, the illustrated message content interface 306′ is only for illustrative purpose, and that different data fields may instead be used.

The supplemental content for the message content 310 may include image data 330 and description data 320. By associating the message content 310 with supplemental content, the processor module 112 may generate, using the message content 310, different social media messages by using different supplemental content. The inclusion of the supplemental content in the social media messages is described below.

The message content interface 306′ includes data fields provided on the message content interface 306 of FIG. 3A as well as a description control 322 for adding description fields 320, such as 320A to 320C and an image control 332 for adding image data 330, such as 330A to 330C. As illustrated in FIG. 3B, each of the description fields 320A to 320C includes a different description text related to the message content 310 and each of the image data 330A to 330C is a different image related to the message content 310.

In some embodiments, the processor module 112 receives an expiry date associated with the message content 310. For example, as illustrated in the message content interface 306′ of FIG. 3B, an expiry data field 340 may be included for receiving a date indicating when the message content 310 is no longer valid. The message content 310 in the example of FIG. 3B expires on Mar. 1, 2014 and therefore, the processor module 112 may remove the message content 310 from the storage module 120 on Mar. 1, 2014.

The message content 310 may include real estate content. Real estate content can include general real estate information, such as real estate news, advice and trends, and real estate listings providing information on a property for sale. The generation of social media messages based on real estate content, such as real estate listings, may be a helpful marketing tool for real estate agents. Social media networks are becoming a crucial marketing platform for professionals. Therefore, a real estate agent with a regular social media presence gains a marketing advantage.

It will be understood that the described embodiments can similarly be applied to different professional fields for which effective marketing is critical in gaining business and clients. For example, the described embodiments can be applied to other sales agents, such as in insurance and mortgage, and fitness instructors.

With respect to real estate, social media messages that are based on real estate listings may increase the visibility of that real estate listing and the number of real estate agents who can be associated with that real estate listing. Real estate agents who represent a property owner in the sale of their property can be referred to as listing agents. Listing agents are typically more senior real estate agents and earn a commission whenever their real estate listing is sold. Selling agents, on the other hand, are real estate agents who earn a commission when buyer clients they bring to different real estate listings make a purchase. Selling agents are typically more junior real estate agents. Since listing agents will earn a commission as long as the real estate property they represent is sold, a listing agent is likely to benefit from any additional promotion of their real estate listings and therefore, listing agents benefit by authorizing their real estate listings to be included in social media messages that are generated by the content system 110 and distributed to other real estate agents. Similarly, selling agents also benefit when social media messages with real estate listings are generated by the content system 110 and distributed to their social media accounts since their perceived portfolio of listings increases with minimal effort on their part and as a result, potentially attracting new buyer clients to them.

Reference is now made to FIG. 4A, which illustrates a screenshot 400 of a real estate content interface 406 for receiving a real estate content 410. In the example of FIG. 4A, the real estate content 410 is a real estate listing. It will be understood that the illustrated real estate content interface 406 is only for illustrative purpose, and that different data fields may be used.

The real estate content interface 406 may include various data fields for receiving data associated with the real estate content 410. As illustrated in FIG. 4A, the real estate content 410 can include information related to the property and the sale of the property. For example, the data fields can include a location field 412, a category dropdown list 414, an address field 416, a listing agent field 418, a price field 450, a published listing identifier field 452 and an authorization indicator field 454. The location field 412 receives geographical data (e.g., city, neighbourhood, etc.) associated with the property, the address field 416 receives a physical address of the property, the listing agent field 418 receives a name or an identifier associated with the listing agent and the price field 450 receives a listing or asking price for the property. The published listing identifier field 452 receives an identifier corresponding to a proprietary publication of the real estate listing. For example, the proprietary publication can be a real estate listing provided by the MLS or other similar services. The category dropdown list 414 provides a list of categories from which at least one category can be selected to be associated with the real estate content 410.

The authorization indicator field 454 receives an indication of whether the real estate content 410 can be shared with other users. As described above, a real estate property is represented by at least one listing agent. That listing agent may allow the real estate listing to be included in social media messages generated by the content system 110 and for the content system 110 to distribute the social media message to other users of the content system 110. In the example of FIG. 4A, the authorization indicator field 454 is selected and therefore, the content system 110 can generate social media messages for other users based on the real estate listing 410.

In some embodiments, the authorization indicator field 454 can include additional data fields for customizing the scope of the authorization. The authorization indicator field 454 may further indicate certain limitations on how a social media message based on the real estate content 410 is used. For example, the authorization indicator field 454 can include a field for designating a time frame within which the real estate content 410 can be included in a social media message, types of real estate agents who can receive a social media message based on the real estate content 410, and frequency in which the real estate content 410 is used in social media messages. It will be understood that the authorization indicator field 454 can include other different limitations.

In the example of FIG. 4A, the real estate content 410 includes a location “Toronto, Ontario” received from the location field 412, an address “1234 Long Blvd.” received from the address field 416, a listing agent named “John” from the listing agent field 418, a price of $300,000 from the price field 450, and a MLS number “1234” from the published listing identifier field 452. The category of the real estate content 410 is selected as “Toronto” from the category dropdown list 414.

Similar to the message content 310 described above with reference to FIG. 3B, the processor module 112 may also receive supplemental content for each real estate content 410. The processor module 112 may also store the supplemental content in the storage module 120.

Reference is now made to FIG. 4B, which illustrates a screenshot 402 of another real estate content interface 406′ for receiving the real estate content 410. It will be understood that, like the real estate content interface 406 of FIG. 4A, the illustrated real estate content interface 406′ is only for illustrative purpose, and that different data fields may instead be used.

Similar to the message content interface 306′ of FIG. 3B, the supplemental content for the real estate content 410 may include image data 430 and description data 420. The real estate content interface 406′ includes data fields provided on the real estate content interface 406 of FIG. 4A and a description control 422 for adding description fields 420, such as 420A to 420C, and an image control 432 for adding image data 430, such as 430A to 430C. As illustrated in FIG. 4B, each of the description fields 420A to 420C includes a different description text related to the real estate content 410 and each of the image data 430A to 430C is a different image related to the real estate content 410.

At 220, the processor module 112 associates each message content 310 in the plurality of message contents with at least one category in a plurality of categories.

The processor module 112 associates the message content 310 with at least one category. The processor module 112 may determine the categories based on data provided in the message content 310. For example, the category of the message content 310 can be the category selected from the category dropdown list 314, or based on keywords in the message content 310. As generally described above, the categories may include, without limitations, a geographical area category, a subject category, and a content type category.

The geographical area category may indicate a location or general region for which the message content 310 is associated. As illustrated in FIGS. 4A and 4B, the geographical area selected for the real estate content 410 using the category dropdown list 414 is Toronto. The geographical area category may include different levels of geography, such as a national category, a regional category and a local category. The processor module 112 may associate any message content 310 that includes data that is applicable nationwide with the national category, any message content 310 that includes data that is applicable within a region (e.g., a province in Canada or a state in the United States) with the regional category, and any message content 310 that includes data that is applicable locally with the local category. For example, the processor module 112 may associate a message content that includes inspirational quotes with the national category since inspirational quotes are generally not geographically limited, a message content related to the condominium market in British Columbia with the regional category, and a message content that includes a real estate listing for Toronto, such as the real estate content 410, with the local category.

The geographical area category may further include user-defined geographical categories that correspond to certain types of geography instead of geographical locations. For example, user-defined geographical categories can include, without limitations, urban category, suburban category, farm category, warm climate category, cold climate category, oceanic category and landlocked category.

The subject category may indicate a topic of the message content 310. For example, the subject category can include, without limitations, a wide breadth of topics, such as an informational category which indicates the message content 310 is related to general news, lifestyle category, home inspection category, real estate category, insurance category, fitness category, and mortgage category. As illustrated in FIG. 3A, the subject category selected for the message content 310 using the category dropdown list 314 is the informational category.

The content type category may identify a type of the message content 310. For example, the content type category can include, without limitations, an article category, a blog entry category, a real estate listing category, an image category, a video category and a general message category. Inspirational quotes, for instance, may be associated with the general message category.

For embodiments in which the message content 310 includes the real estate content 410, the processor module 112 may use different or additional categories, such as a category based on a type of real estate property. The type of real estate property may include a rental home, a vacation home, a condominium, a house and other types of real property. Other categories that are more specific to the real estate field may similarly be used.

At 230, the processor module 112 determines, for at least one user in the plurality of users, one or more categories from the plurality of categories using the content indicator associated with the at least one user.

The content indicator may include default preferences provided by the content system 110 and user preferences provided by the user.

As described at 210, each user profile includes a content indicator for indicating characteristics of the social media message to be generated for the user. For example, the characteristics may include the type of message content 310 (e.g., articles, images, real estate listings, etc.), a frequency at which the content system 110 generates social media messages for that user, and an order, or sequence, in which the processor module 112 determines the categories of the message content 310 for that user.

The frequency in which the content system 110 generates a social media message for a user may be provided as a number of social media messages within a predefined time period (e.g., three social media messages in a week) or a total number of social media messages for the duration of that user's subscription to the content system 110.

The processor module 112 may determine, for the user, categories of the message content 310 based on a predefined order as provided in the content indicator. By using the predefined order, the content system 110 may increase the variety of the message content included in the social media messages generated for that user. The predefined order may include a category sequence. As well, the predefined order provides the content system 110 and the user with greater control over the frequency in which certain types of message contents appear in the generated social media messages.

For example, if the category sequence includes the national category and the local category. The processor module 112 determines the category by alternating between the national category and the local category. If the predefined order is not used, the processor module 112 may determine the national category consecutively.

Also, by spreading out the categories that are determined by the processor module 112, there is smaller likelihood that a message content 310 is repeated for a user. Certain categories, such as the national category, are likely to be associated with a greater number of different message contents than other categories, such as the local category. Therefore, the use of a predefined order in which certain categories are determined by the processor module 112 increases the variety of the message contents for a user.

The content indicator may include specific categories of the message content 310 as selected by the user or a pre-defined order of categories as selected by the user. If the content indicator includes specific categories selected by the user, the processor module 112 may sequentially determine one of those categories selected by the user. The content indicator may instead include a default order in which categories of the message content 310 is determined by the processor module 112.

An example order in which different categories of the message content 310 is determined by the processor module 112 can be a sequence involving the national category, the regional category and the local category. For a user profile associated with this example order, the processor module 112 can determine, for that user, the national category for a first social media message, the regional category for a second social media message, the local category for a third social media message, and so on. Another example order in which different categories is determined by the processor module 112 can be a sequence involving inspirational quotes, the regional category, the real estate listings and images.

Referring now to FIGS. 5A to 5C, which are screenshots of example social media messages based on different message contents 510, 512 and 514, respectively, for a user, “Shaun”, with a user identifier 540. In the example illustrated in FIGS. 5A to 5C, the user identifier 540 is associated with a content indicator that indicates the categories of the message content 310 should be based on a sequential order including a national category, a regional category and a local category. The social media message 570 of FIG. 5A includes the message content 510 which is associated with the national category (e.g., the condo market in Canada), the social media message 572 of FIG. 5B includes the message content 512 which is associated with the regional category (e.g., Celebrity homes in California), and the social media message 574 of FIG. 5C includes the message content 514 which is associated with the local category (e.g., a real estate listing for a home in Toronto). Each of the social media messages 570, 572, and 574 also includes an image 530, 530, and 534, respectively. The processor module 112 can continue to generate social media messages for the user “Shaun” based on the order provided by the associated content identifier.

It will be generally understood that an order in which the categories of the message content is determined by the processor module 112 can include any number of categories.

At 240, the processor module 112 determines, for the at least one user, a message content 310 from the plurality of message contents based on the determined one or more categories.

After determining the one or more categories based on the content indicator associated with the user, the processor module 112 determines the message content 310 based on the determined category. Depending on the category, the message content 310 may include the real estate content 410.

In some embodiments, the content indicator can further specify that a message content can be used for a user for a limited number of times. For example, the content indicator may specify that no message content can be used more than once when generating social media messages for that user. The user profile for a user may be associated with a record all message contents that were used for generating social media messages for that user. When the processor module 112 selects a message content that was previously used for generating a social media message for that user, the processor module 112 selects another message content. In the case that no other message content is available, the processor module 112 may determine another category or not generate a social media message for that user at that time.

In some embodiments, the processor module 112 also determines at least one supplemental content from the supplemental contents that are associated with the message content 310. As described above, the supplemental contents can include image data and description data.

At 250, the processor module 112 creates, for the at least one user, the social media message based on the determined message content 310.

Reference is now made to FIG. 6, which is a screenshot of a social media message 670 generated based on the message content 310 provided from the message content interface 306 of FIG. 3A. It will be understood that the illustrated social media message 670 is only for illustrative purpose, and that different data may be included in the social media message 670.

In the example of FIG. 6, the processor module 112 generated the social media message 670 for a user, namely “Leslie”, associated with user identifier 640. The social media message 670 includes the title 312, the subtitle 316 and the content URL 362 received from the corresponding data fields on the message content interface 306. As shown in FIG. 3A, the message content 310 is associated with the informational category based on the category dropdown list 314 and can further be associated with the regional category since the message content 310 is related to a mansion located in California. The processor module 112, therefore, may determine the message content 310 for the user “Leslie” because the content indicator in her user profile is associated with at least the regional category or the informational category.

It will be understood, though, that the processor module 112 may generate the social media message 670 using only the message content 310 received from the content fields 360. That is, the title 312 and the subtitle 316 may be optional or may even form part of the supplemental content.

The processor module 112 may generate social media messages for multiple users. For example, when generating social media messages for a first user and a second user, the processor module 112 can determine a first message content for the first user and a second message content for the second user. The first message content and the second message content may be identical or different. In some cases, the processor module 112 may further determine supplemental content for each of the first user and the second user. In the case that the first message content is the same as the second message content, the processor module 112 may determine supplemental content for the first user that is different from the supplemental content for the second user in order to generate different social media messages that are different for the first user and the second user. However, the processor module 112 may determine supplemental content that is the same for the first user and the second user.

FIGS. 7A and 7B illustrate screenshots of social media messages 770A and 770B, respectively, generated based on the message content 310. Unlike the social media message 670, the social media messages 770A and 770B include supplemental content provided from the message content interface 306′ of FIG. 3B.

Similar to the social media message 670 of FIG. 6, the processor module 112 generated the social media message 770A for the user, “Leslie”. In addition to the title 312, the subtitle 316 and the content URL 362 provided in social media message 670, the social media message 770A further includes the image data 330A and the description data 320A associated with the message content 310.

The social media message 770B was generated by the processor module 112 for a user, “Grace”, associated with user identifier 740. The social media message 770B was also generated based on the message content 310 and therefore, includes the title 312, the subtitle 316 and the content URL 362 provided in social media message 670. However, despite being based on identical message content 310, the social media messages 770A and 770B are different since they each include different supplemental content. As illustrated in FIG. 7B, the social media message 770B includes the image data 330B and the description data 320B.

In some embodiments, the message content 310 can include the real estate content 410.

Reference is now made to FIGS. 8A to 8C, which illustrate screenshots of example social media messages 870A, 870B and 870C, respectively, generated based on the real estate content 410 provided from the real estate content interface 406′ of FIG. 4B. It will be understood that the illustrated social media messages 870A, 870B and 870C are only for illustrative purpose, and that different data may be included each of the social media messages 870A, 870B and 870C.

Although the processor module 112 generated the social media messages 870A, 870B and 870C based on the same real estate content 410 for different users, the social media messages 870A, 870B and 870C are different from each other due to the use of supplemental content. Each social media message 870A, 870B and 870C includes the physical address from the address field 416, the price from the price field 450 and the location from the location field 412 received from the real estate content interface 406′ of FIG. 4B.

However, social media message 870A includes the image data 430B and the description data 420B, social media message 870B includes the image data 430C and the description data 420C, and social media message 870C includes the image data 430A and the description data 420A.

The social media messages 870A, 870B and 870C are generated by the processor module 112 based on the real estate content 410, which is a real estate listing. The social media messages 870A, 870B and 870C may also include a URL corresponding to a webpage for that real estate listing. The webpage may be provided by the content system 110.

For example, the URL for the real estate listing can be embedded in the social media message 870A so that any selection of the social media message 870A redirects a display of the user device 140 to the webpage for that real estate listing, such as listing interface 900 of FIG. 9A for displaying a real estate listing 910. The listing interface 900 includes the real estate listing 910 and an agent contact control 904. When the content system 110 receives a selection via the agent contact control 904, the content system 110 may generate an interface, such as contact agent interface 980 of FIG. 9B, for contacting a real estate agent associated with the real estate listing 910. The listing interface 900 may include other fields and controls for receiving input from a potential client. For example, the listing interface 900 may further include a comment field from which the content system 110 may receive comments or questions from the potential client, or an appointment request field from which the content system 110 may receive a request for making an appointment for a showing of the property. It will be understood that the listing interface 900 may include other similar fields and controls for enabling interaction with the content system 110.

The processor module 112 may create any of the above social media messages based also on the user profile of the user for which the social media message is generated. In some embodiments, the processor module 112 may associate the social media message with a user identifier corresponding to that user.

Continuing with the example described above with reference to FIG. 9A, the URL for the real estate listing 910 may include the user identifier 640 for the user, Leslie, for which the social media message 870A was generated. Therefore, as illustrated in FIG. 9B, the contact agent interface 980 can include contact information associated with the user identifier 640 instead of contact information associated with the listing agent identifier 418. Similarly, if other fields and controls are provided on the listing interface 900, the content system 110 may forward any input received via those fields and controls to the user, Leslie, since the user identifier 640 is associated with the URL for the real estate listing 910.

Creating the social media message for a user may further include distributing the social media message to at least one social media server 130 associated with that user. The social media message may then be posted or associated with a user account on each of the social media servers 130 associated with that user.

In some embodiments, for a user associated with multiple social media servers 130, the processor module 112 may generate social media messages that are based on different message contents 310 for each of the different social media servers 130. For example, for a user profile that is associated with Facebook and Twitter, the processor module 112 can generate a social media message for Facebook based on a first message content and a social media message for Twitter based on a second message content that is different from the first message content. Also, the processor module 112 may generate different social media messages based on different requirements, such as formatting standards, of the social media servers. For example, the processor module 112 can generate a social media message for Facebook using a different formatting standard than a social media message generated for Twitter since social media messages on Twitter are limited to 140 characters.

FIG. 10 illustrates a screenshot of example social media statistics 1000 for a user. The content system 110 may provide, for each user, social media statistics 1000 for tracking and monitoring a user's social media activities. For example, the social media statistics 1000 can include a feedback summary 1010 for generally illustrating the different types of feedback received for social media messages generated by the content system 110 for the user, a social media network summary 1020 providing a number of network connections that the user has in each associated social media server 130, a readership summary 1030 providing a frequency in which social media messages generated by the content system 110 for the user is accessed by his or her network connections, a social media score 1040 calculated based on various factors, such as the readership summary 1030 and the social media network summary 1020 for example, and an activity summary 1050 providing a number of social media messages generated by the content system 110 for the user. It will be understood that other data may similarly be collected and summarized in the social media statistics 1000.

The feedback summary 1010 may illustrate the feedback received for the social media messages provided on the user's social media accounts. For example, the feedback may include a number of times each social media message is selected, a number of comments provided for each social media message, and a number of times the content system 110 received a request for the user's contact information. It will be understood that other types of feedback data may similarly be collected for the user.

The feedback summary 1010 may further include feedback received on any social media messages that includes message contents 310 that originated from that user. Referring briefly to FIGS. 4B and 8A-8C, the feedback summary 1010 for the listing agent, John, can include feedback received on social media messages generated by the content system 110 for John and also feedback received on any of the social media messages 870A to 870C that the content system 110 generated for the users, Leslie, Grace and Shaun, respectively.

The present invention has been described here by way of example only. Various modification and variations may be made to these exemplary embodiments without departing from the scope of the invention, which is limited only by the appended claims. Also, in the various user interfaces illustrated in the figures, it will be understood that the illustrated user interface text and controls are provided as examples only and are not meant to be limiting. Other suitable user interface elements may be possible.

We claim:

1. A method of generating a social media message, the method comprising:
storing, in a storage module, a user profile corresponding to each user in a plurality of users and at least one message content in a plurality of message contents, the user profile includes a content indicator corresponding to one or more categories of message content selected by a corresponding user; and
operating at least one processor module to:
associate each message content in the plurality of message contents with at least one category in a plurality of categories;
determine, for at least one user in the plurality of users,
one or more categories from the plurality of categories using the content indicator associated with the at least one user; and
a message content from the plurality of message contents based on the determined one or more categories; and
create, for the at least one user, the social media message based on the determined message content.

2. The method of claim 1 further comprising operating the at least one processor module to:
store one or more supplemental contents associated with each message content in the plurality of message contents;
determine, for the at least one user, at least one supplemental content from the one or more supplemental contents associated with the determined message content; and
create, for the at least one user, the social media message based on the determined at least one supplemental content.

3. The method of claim 2, wherein:
each user profile is associated with at least one social media server of a plurality of social media servers and further includes authentication information associated with the at least one social media server; and
operating the at least one processor module to create the social media message further comprises distributing the created social media message to the at least one social media server associated with the at least one user.

4. The method of claim 2, wherein:
the one or more supplemental contents associated with each message content includes a plurality of images and a plurality of descriptions; and
the determined at least one supplemental content comprises an image from the plurality of images and a description from the plurality of descriptions.

5. The method of claim 2, wherein:
the at least one user comprises a first user and a second user; and
operating the at least one processor module to determine a message content further comprises determining:
a first message content from the plurality of message contents for the first user and a second message content from the plurality of message contents for the second user; and
at least one supplemental content associated with the first message content and at least one supplemental content associated with the second message content; and
operating the at least one processor module to create the social media message further comprises creating a first social media message based on the first message content and a second social media message based on the second message content.

6. The method of claim 5, wherein:
the first message content is identical to the second message content;
the at least one supplemental content associated with the first message content is different from the at least one supplemental content associated with the second message content; and
the first social media message is different from the second social media message.

7. The method of claim 6, wherein:
the at least one supplemental content associated with the first message content comprises a first image and a first description;
the at least one supplemental content associated with the second message content comprises a second image and a second description; and
at least one of the first image and the first description is different from the second image and the second description.

8. The method of claim 1, wherein each message content in the plurality of message contents includes at least one of a text data, an image data, a video data and an uniform resource locator (URL).

9. The method of claim 1, wherein the plurality of message contents includes at least one real estate content.

10. The method of claim 1, wherein the plurality of categories includes at least one of a geographical area category, a subject category, and a content type category.

11. The method of claim 10, wherein:
the geographical area category includes at least a national category, a regional category and a local category; and
operating the at least one processor module to determine the one or more categories further comprises determining the one or more categories based on a category sequence providing a predetermined order for selecting one of the national category, the regional category and the local category.

12. The method of claim 1, wherein the at least one message content in a plurality of message contents is associated with an expiry date indicating a date for removing the at least one message content from the storage module.

13. The method of claim 1 further comprising operating the at least one processor module to create, for the at least one user, the social media message based on a user profile of the at least one user, the social media message being associated with a user identifier corresponding to the at least one user.

14. A method of generating a social media message, the method comprising:
storing, in a storage module, a user profile corresponding to each user in a plurality of users and at least one real estate content in a plurality of real estate contents, the user profile includes a real estate interest indicator corresponding to one or more categories of real estate contents selected by a corresponding user; and
operating at least one processor module to:
associate each real estate content in the plurality of real estate contents with at least one category in a plurality of categories;
determine, for at least one user in the plurality of users:
one or more categories from the plurality of categories using the real estate interest indicator associated with the at least one user; and
a real estate content from the plurality of real estate contents based on the determined one or more categories; and
create, for the at least one user, the social media message based on the determined real estate content.

15. The method of claim 14, wherein the at least one real estate content is associated with an authorization indicator allowing the at least one real estate content to be shared with the plurality of users.

16. The method of claim 14 further comprising operating the at least one processor module to:
store one or more supplemental contents associated with each real estate content in the plurality of real estate contents;
determine, for the at least one user, at least one supplemental content from the one or more supplemental contents associated with the determined real estate content; and
create, for the at least one user, the social media message based on the determined at least one supplemental content.

17. The method of claim 16, wherein:
each user profile is associated with at least one social media server of a plurality of social media servers and further includes authentication information associated with the at least one social media server; and
operating the at least one processor module to create the social media message further comprises distributing the created social media message to the at least one social media server associated with the at least one user.

18. The method of claim 14, wherein the plurality of categories includes a geographical location and a type of real estate property.

19. The method of claim 16, wherein:
the one or more supplemental contents associated with each real estate content includes a plurality of images and a plurality of descriptions; and
the determined at least one supplemental content comprises an image from the plurality of images and a description from the plurality of descriptions.

20. The method of claim 19, wherein:
the at least one user comprises a first user and a second user;
operating the at least one processor module to determine a real estate content further comprises determining:
a first real estate content from the plurality of real estate contents for the first user and a second real estate content from the plurality of real estate contents for the second user; and
at least one supplemental content associated with the first real estate content and at least one supplemental content associated with the second real estate content; and
operating the at least one processor module to create the social media message further comprises creating a first social media message based on the first real estate content and a second social media message based on the second real estate content.

21. The method of claim 20, wherein:
the first real estate content is identical to the second real estate content;
the at least one supplemental content associated with the first real estate content is different from the at least one supplemental content associated with the second real estate content; and
the first social media message is different from the second social media message.

22. The method of claim 21, wherein:
the at least one supplemental content associated with the first real estate content comprises a first image and a first description;
the at least one supplemental content associated with the second real estate content comprises a second image and a second description; and
at least one of the first image and the first description is different from the second image and the second description.

23. The method of claim 14 further comprises operating the at least one processor module to create the social media message based on the user profile of the at least one user, the social media message being associated with a user identifier corresponding to the at least one user.

24. The method of claim 23, wherein:
each real estate content in the plurality of real estate contents is associated with a listing agent identifier; and
the social media message includes contact information associated with the user identifier instead of contact information associated with the listing agent identifier.

25. A method of generating a social media message for at least one user in the plurality of users, the method comprising:
storing, in a storage module, a user profile corresponding to each user in the plurality of users and at least one real estate content in a plurality of real estate contents, the user profile includes a real estate interest indicator corresponding to one or more categories of real estate contents selected by a corresponding user; and
operating at least one processor module to:
associate each real estate content in the plurality of real estate contents with at least one category in a plurality of categories;
determine, for the least one user:
one or more categories from the plurality of categories using the real estate interest indicator associated with the at least one user; and
a real estate content from the plurality of real estate contents based on the determined one or more categories; and
create, for the at least one user, the social media message based on the determined real estate content and the user profile of the at least one user, the social media message being associated with a user identifier corresponding to the at least one user.

26. The method of claim 25, wherein:
each user profile is associated with at least one social media server of a plurality of social media servers and further includes authentication information associated with the at least one social media server; and
operating the at least one processor module to create the social media message further comprises distributing the created social media message to the at least one social media server associated with the at least one user.

27. The method of claim 25, wherein:
each real estate content in the plurality of real estate contents is associated with a listing agent identifier; and
the social media message includes contact information associated with the user identifier instead of contact information associated with the listing agent identifier.

28. The method of claim 25, wherein the plurality of categories includes a geographical location and a type of real estate property.

29. The method of claim 25 further comprises operating the at least one processor module to:
store one or more supplemental contents associated with each real estate content in the plurality of real estate contents; and
determine, for the at least one user, at least one supplemental content from the one or more supplemental contents associated with the determined real estate content.
